(19) United States
(12) Patent Application Publication
(10) Pub. No.: US 2024/0181975 A1
(43) Pub. Date: Jun. 6, 2024

(54) METHOD FOR PRODUCING A SOUND INSULATION WITH FLEECE INSULATION AND SOUND INSULATION

(71) Applicant: Adler Pelzer Holding GmbH, Hagen (DE)

(72) Inventors: Oussama AL SAYED SABSABI, Hagen (DE); Volkmar SCHULZE, Hagen (DE)

(21) Appl. No.: 18/285,517

(22) PCT Filed: Feb. 22, 2022
(86) PCT No.: PCT/EP2022/054460

§ 371 Date: Oct. 4, 2023

(30) Foreign Application Priority Data
Apr. 7, 2021 (DE) 10 2021 108 602.7

(51) Int. Cl. B60R 13/08; B32B 1/00; B32B 5/02; B32B 5/26; B32B 7/022

(52) U.S. Cl. CPC B60R 13/083; B32B 1/00; B32B 5/022; B32B 5/266; B32B 7/022; B32B 2307/102; B32B 2307/536; B32B 2307/554; B32B 2605/003

(57) ABSTRACT

A one-step process for the production of a paneling is provided and, in particular, floor paneling for a motor vehicle with an insulation of fiber/absorbent nonwoven, as well as possibly further absorbent layers, which can differ zonally (partially) over the area and thickness of the insulation in their mechanical-physical and acoustic properties. The focus are nonwoven structures whose fiber orientation is perpendicular to the surface/wear layer of the floor paneling.

### CROSS-REFERENCE TO RELATED APPLICATIONS

This application claims priority to PCT Application No. PCT/EP2022/054460, having a filing date of Feb. 22, 2022, based on German Application No. 10 2021 108 602.7, having a filing date of Apr. 7, 2021, the entire contents both of which are hereby incorporated by reference.

### FIELD OF TECHNOLOGY

The following is a method and, in particular, a one-step method for producing a paneling, and in particular a floor paneling for a motor vehicle, with an insulation of fiber/absorbent nonwoven, as well as optionally further absorbent layers, which can differ zonally (partially) over the area and/or thickness of the insulation in their mechanical-physical and acoustic properties. The focus is on nonwoven structures whose fiber orientation is perpendicular or at a certain fiber orientation angle to the surface or wear layer of the floor paneling.

### BACKGROUND

The aim is to improve the acoustic effectiveness of floor trim systems in motor vehicles as a result of a soft or gentle coupling of the fiber/absorption insulation as a whole to the wear layer; the surface/visible surface layer with any layers underneath. In an embodiment, a density reduction of the fiber/absorption layer(s) of the insulation and thus a weight optimization shall also be achieved.

Furthermore, a reduction in cycle time in the production process stages is also desired, which in turn has a positive effect on the economic efficiency of the overall process.

The floor linings used in motor vehicles today generally have material structures comprising a wear layer—consisting of the surface/visible layer with adhesive layers underneath, acoustic/strengthening nonwovens, sealing and heavy foils as well as contact/foil nonwovens—and the insulation.

Various designs of floor paneling-wear layers are known in the state of the conventional art; tufted, velour and flat needlefelt carpets are widely used as surface/visible surface layers. In particular for vans, SUVs, pickups and light commercial vehicles, rubber, PUR-RIM, PVC and increasingly TPO (surface-textured/with grain) are also used in the state of the conventional art as surface/visible layer of the wear layer.

For tufted carpets, PA6.6, PA6, PP, rPA and PET, rPET as well as the bio-based polyamides (PA 5.10; PA 6.10) or wool are used as yarn/filament material. In the field of velour and flat needle punch carpets, PET, PET/PP, PP, PA/PET and rPET are predominantly used as fiber material. The tufting carrier for the tufting qualities is mostly made of PET/PP, PET/coPET or PET/PA.

The fiber/filament bindings used here include EVA and PE for tufted carpets and SBR latex or acrylate for velour and flat needle punched carpets. Furthermore, films, nonwovens, adhesives (hot melts), thermoplastics (mainly PE) and the thermo-bonding process described in EP 1 598 476 B1 are used for velour and flat needle punched carpets. Furthermore, bonding fibers, EVA or thermoplastic dispersions are increasingly used.

The underlays, such as acoustic and/or stiffening fleeces, consist of PET and/or mixed fiber fleeces, often with a BiCo fiber content. PE/PA and PE/PA/PE films as well as PE/PA/PE+PET nonwoven films are used as sealing or insulating films. Depending on the acoustic requirements, so-called heavy foils are also used as partial and/or full-surface insulating foils.

Between the wear layer (often generally referred to as the top layer) and the car body floor there is an insulation layer, which can be formed in particular from PUR foam or non-woven structures (non-woven or fiber flock (HMP) composites). If a foam is used, it is firmly bonded (and in particular foamed) to the wear layer. Non-woven/fiber flock structures can also be firmly bonded to the wear layer, wherein these are then usually glued or also fused.

However, it is also possible to lay them on top of each other without a fixed connection.

In the state of the conventional art, the following floor paneling insulations are essentially known:
a.) viscoelastic foam, DE 39 05 607 A1, WO 2006/032433 A1;
b.) lightweight foam (cut foam), DE 10 2008 017 893 A1 (partial);
c.) foam with partially different density, EP 0 210 102 B1, EP 0 169 627 A2;
d.) nonwoven (glued/laminated nonwoven die-cuts);
e.) preformed (glued on) nonwovens;
f.) fiber flock insulation (HMP), DE 10 2008 013 808 A1, DE 103 24 735 B3;
g.) nonwovens with standing/vertical fiber orientation, US 2017/0008462 A1, U.S. Pat. No. 9,321,412 B2;
h.) fiber flock insulation (HMP) with standing/vertical fiber orientation, DE 10 2012 003 093 A1, DE 10 2010 034 159 A1;
i.) pressed fiber material consisting of fiber balls, DE 20 2020 101 433 U1; and
j.) combination of fiber flock layers with further fiber flock layers or non-woven or foam layers, DE 10 2021 101 921.4, DE 10 2021 101 922.2.

It is also known that so-called crash elements, floor mat fastening elements and footrest elements are integrated in the insulation. EPS, EPP and PEPP inserts are also mainly placed in the insulation to increase the step stiffness, among other things. DE 10 2009 058 819 A1 describes a structure with spacers for this purpose. Furthermore, it is known to foam composite foam pieces (DE 36 23 789 A1). DE 20 2008 004 918 U1 states that anti-drumming foils are (partially) applied to the carpet composite at several points in a force-fit or material-fit manner.

The advantage of using fiber insulation produced in the fiber flock (HMP) process is mainly that the weight per unit area of the insulation can be influenced to a large extent over the surface of the component and adapted to local requirements.

Various methods can be found in the conventional art for this purpose; see in particular DE 44 30 961 A1, DE 103 24 735 B3, DE 10 2012 019 534 A1, DE 10 2015 112 187 A1, DE 10 2008 013 808 A1 and DE 10 2015 200 275 A1.

WO 2019/007 660 A1 discloses a three-layer insulation, fiber layer/film (possibly perforated)/fiber layer. Here, the first fiber layer (the one facing the wear layer) is a nonwoven (carded, air lay); the foil located between the porous fiber layers act as an adhesive and flow “nonwoven”.

In an embodiment, the method described in DE 10 2008 013 808 A1 allows, in particular through the use of guiding sheets and special throttle valves, a demand-oriented distribution of the fiber/flock mixture over the surface of the insulation to be produced.

So-called thermoforming plants are used for the production of floor paneling in the automotive industry, the forming of the wear layer, where the individual layers of the wear layer are in the form of blanks or rolls. These can be operated fully automatically, semi-automatically or in a manual process.

In the state of the conventional art, thermoforming plants with the following apparatuses are known, each of which is arranged one behind the other in a throughput direction: Fabric storage>Storage table>Contact heating panel>Contact heating panel>Radiant heating panel>Forming tool Fabric storage>Storage table>Contact heating panel>Radiant heating panel>Forming tool Fabric storage>Storage table>Contact heating panel>Contact heating panel>Forming tool Fabric storage>Storage table>Contact heating panel>Forming tool Fabric storage>Storage table>Radiant heating panel>Forming tool

The transport of the laid composite (the wear layer) is carried out by transport and gripper systems. It is also common to place partial individual layers on the storage table using pick-and-place.

DE 10 2018 114 125 A1 discloses a production process with associated apparatus for the production of shaped textile multilayer composites, which in particular guarantees a reduction in the material requirement and cycle times; and the introduction of the heat required for laminating and shaping is also made possible with short cycle times.

DE 10 2012 222 000 A1 discloses a method for the production of at least two-layer components as absorptive paneling in the interior and/or luggage compartment or for floor paneling of motor vehicles comprising an upper material and a carrier, wherein
(a) a carrier material containing filler and binder, formed on one side in a flock box, is introduced into a steam/vacuum tool,
(b) the top material cut to the shape of a blank is inserted into the tool with its flow-closed side facing the carrier material,
(c) the tool closes,
(d) the top material is formed by applying vacuum to its face side while solidifying the carrier material by applying first vacuum and then steam/vacuum from its underside, thereby forming the component into final contour and bonding the top material and carrier material together; and
(e) subsequently cooling the component in a calibration tool or storage tray.

DE 10 2021 101 921.4 and DE 10 2021 101 922.2 describe methods for the production of floor lining insulation or sound-insulating paneling, and in particular floor linings for a motor vehicle, which insulation comprises fibers and/or consists of or comprises flocked fiber layers.

No methods and apparatuses are known from the conventional art that disclose a one-step technology, wear layer plus non-woven insulation layer, in the production of floor panelings with different thickness and density distributions of the non-woven insulation layer over the surface of the floor paneling.

### SUMMARY

An aspect relates to a one-step method for the production of a paneling and in particular a floor paneling for a motor vehicle, with non-woven insulation, in which in particular the wear layer and the non-woven insulation are formed in one step to form a floor paneling; wherein in particular the insulation has different mechanical-physical and acoustic properties over the surface and thickness.

In an embodiment, nonwovens with vertical fiber orientation are used here, as the fibers (with elastic properties) are thus oriented in the direction of the load and thus have a preferential influence on the mechanical properties.

Highlights include high compression resistance/recovery performance even at low densities, high thicknesses at low densities for lightweight components with good acoustics, good thermoformability with good stretch properties and, in particular, good thermoforming behavior and radius runnability, as well as high thickness stability that can be controlled independently of weight.

In general, for the production of nonwovens with vertically oriented fibers, the aerodynamic process is reported in WO 2009/056745 A2 and the Struto process in WO 2005/081226 A1.

In a first embodiment, it is an aspect of embodiments of the present invention to provide a method for producing a sound insulation, a paneling and, in particular, a floor paneling (or a sound-insulating paneling and in particular floor paneling) with non-woven insulation for a motor vehicle, wherein the non-woven insulation (and/or the floor paneling) has different acoustic and/or mechanical-physical properties over the area and thickness of the non-woven insulation, and the floor paneling has at least one material structure wear layer (a surface/visible surface layer, with adhesive layers, acoustic and/or stiffening non-wovens and/or sealing and heavy foils and/or contact/foil non-wovens located underneath) and the non-woven insulation.

According to embodiments of the invention, the nonwoven insulation is a single-layer or multi-layer nonwoven which has a density distribution (distribution of weight per unit area, or a changing density) over the length and/or width and which has fibers oriented over the entire surface or partially towards the wear layer.

In an embodiment, the floor paneling and/or the nonwoven insulation extends in a length or longitudinal direction, a width or width direction and in a thickness or thickness direction. In an embodiment, the length, the width and the thickness are perpendicular to each other. The above-mentioned area is defined by the length and the width.

In this method, the (in particular tempered) nonwoven (for example the nonwoven board) is positioned in a forming tool (floor paneling), and this is preformed by briefly closing and reopening the forming tool.

Short closing (mold closing time) is understood to mean in particular a period of time between 1 and 5 seconds.

Furthermore, larger thicknesses and/or contour jumps of the insulation are compensated and in particular by adding and in particular blowing in fibers or inserting nonwoven pads.

In particular, this concerns the difference between the thickness of the nonwoven used (initial nonwoven thickness) and the total thickness of the insulation, which can be between 0 and 125 mm.

In an embodiment, the (in particular also tempered and in particular heated) wear layer (in the blank) is arranged above or over the insulation.

Furthermore, the forming tool closes and opens after a defined mold closing time, which can be between 15 and 95 seconds depending on the material structure of the floor paneling system. The formed wear layer with (in particular materially bonded) nonwoven insulation is removed and then trimmed, which can be done by water jet or by punching, for example.

The pads can be positioned in 2D board form or in 3D preformed form; these serve, in addition to thickness/contour compensation, to simultaneously improve insulation and thus component stiffness.

In a further embodiment of the method according to the invention for producing a sound insulation, a paneling and in particular a floor paneling with nonwoven insulation for a motor vehicle, in particular with small installation space for the paneling or floor paneling itself, and in particular for the nonwoven insulation, in particular accompanied but with small contour jumps (the initial thickness of the insulation nonwoven used corresponds essentially to the insulation installation space of the component; that is, the total thickness of the nonwoven insulation can be covered contour-followingly by the insulating nonwoven used), the floor paneling has a nonwoven insulation which is a single-layer or multilayer nonwoven which has a density distribution (and/or weight per unit area distribution) over length and width and has fibers oriented over the entire surface or partially towards the wear layer, wherein the nonwoven (the nonwoven blank) being positioned in a forming tool (for the paneling and in particular floor paneling), the (in particular tempered) wear layer (in particular in the blank blank) is then placed over it and the forming tool closes and opens after a defined mold closing time (depending on the material structure of the floor paneling system, between 10 and 72 seconds), the formed wear layer with (materially bonded) bonded nonwoven insulation is removed and then trimmed, for example by water jet or by punching.

In an embodiment, the paneling and in particular the floor paneling has at least one material structure wear layer, a surface/visible surface layer (with adhesive layers, acoustic and/or stiffening nonwovens and/or sealing and heavy foils and/or contact/foil nonwovens located underneath) as well as the nonwoven insulation.

The single-layer or multi-layer nonwoven as well as the wear layer are inserted into the forming tool in the board blank in a heated state (tempered in separate process steps, in particular by hot air or a radiant heating field), pressed/formed into the final shape and the three-dimensionally shaped floor paneling is cooled.

In a further embodiment, the nonwoven insulation has a base nonwoven that is partially equipped with nonwoven pads over the surface—in particular as required. Thus, the nonwoven insulation can have a base nonwoven that has nonwoven pads at least partially distributed over the surface.

Recycled sandwich nonwovens, with fiber scattering material of different scattering quantity over length and width in the core layer, are also used. Thus, the nonwoven insulation can have a recycled sandwich nonwoven, fiber scattering material, with particularly different scattering quantity over a length and/or width of the nonwoven, in particular in the core layer.

Furthermore, the nonwoven insulation can have a density distribution over the length and width and/or have fibers oriented towards the wear layer, in particular over the entire surface or partially.

In a further method, the wear layer and the nonwoven insulation are positioned in a forming tool and, in particular, are positioned in the forming tool following the contour of the tool.

The core of embodiments of the present invention is thus the provision of a method for the production of a sound insulation floor paneling with nonwoven insulation for a motor vehicle, which makes it possible to produce a wear layer with, if necessary, sub-layers with a single-layer or multi-layer nonwoven insulation layer, which has a defined density distribution over length and width, in one step.

The advantage of this method is that the density distribution of the nonwoven insulation not only reduces the cycle time in the production process, the individual method steps, but also the weight.

In addition, the recyclability and the use of recycled material should also be mentioned here.

In a method, the wear layer is stretched prior to molding and, in particular, stretched over the course of a longitudinal side to varying degrees in the transverse direction and/or over the course of a transverse side to varying degrees in the longitudinal direction.

In an embodiment, stretching takes place in several directions and in particular stretching to different extents in several directions.

In an embodiment, the methods described above are used for the production of further sound insulation in the interior (of a motor vehicle) and in the luggage compartment.

Embodiments of the present invention are further directed to a sound insulation, a paneling and, in particular, a floor paneling with non-woven insulation for a vehicle, wherein the non-woven insulation and/or the floor paneling has different acoustic and/or mechanical-physical properties over the area and/or thickness, in particular of the non-woven insulation, and wherein the floor paneling has at least one material structure wear layer, a surface/visible surface layer, with sublayers located underneath, and the non-woven insulation.

According to embodiments of the invention, the nonwoven insulation is a single-layer or multi-layer nonwoven which has a density distribution over length and width and which has fibers oriented over the entire surface or partially towards the wear layer, wherein thicknesses and/or contour jumps of the nonwoven insulation are compensated for by inserted elements and in particular by blown-in fibers and/or inserted nonwoven pads.

In an embodiment, the nonwoven insulation is a multilayer nonwoven in which the compression hardness of the nonwoven layer and/or nonwoven layer adjacent to the wear layer is lower than that of the nonwoven layer(s) or nonwoven layer(s) facing the vehicle floor; and is in a range of 0.2 kPa and 5 kPa.

In an embodiment, the sound insulation, the paneling and especially the floor paneling is produced by a method of the type described above.

### BRIEF DESCRIPTION

Some of the embodiments will be described in detail, with reference to the following figures, wherein like designations denote like members, wherein:

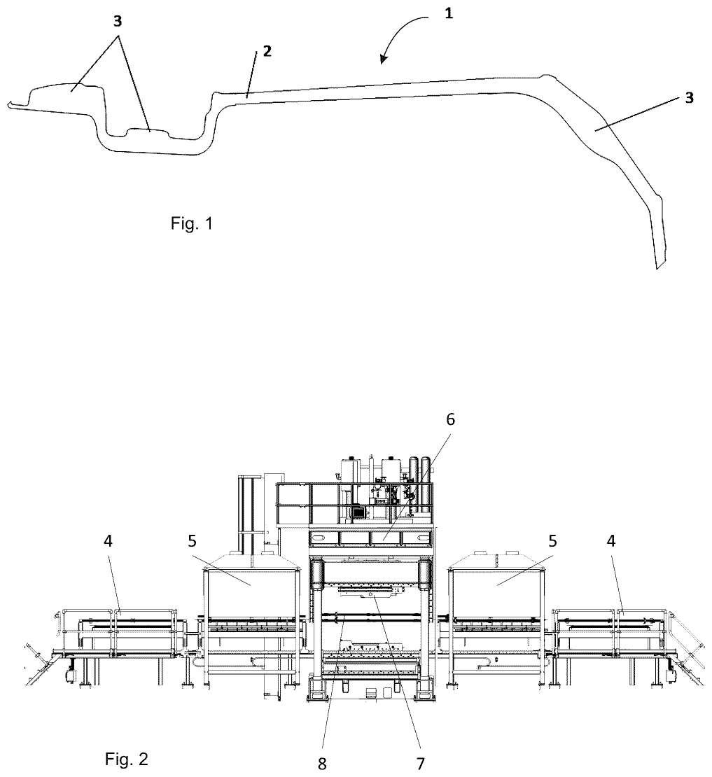

FIG. 1 shows the installation space for the nonwoven insulation of a floor paneling for a motor vehicle; and

FIG. 2 schematically shows the process steps of the method for the production of a sound insulation with nonwoven insulation.

### DETAILED DESCRIPTION

FIG. 1 shows the installation space 1 for a nonwoven insulation 2. The positions 3 show areas in which the nonwoven insulation 2 must be thickened during the production process by blowing in fibers or using pads.

FIG. 2 shows a schematic of an embodiment of the method with the process stages storage table 4 for the wear layer and/or the nonwoven insulation 2, the heating stations 5 and the forming press 6 with the forming tool 7; the transport system 8 for the wear layer as well as the nonwoven insulation 2 connects the process stages.

Not shown are the fabric stores for pads and fibers for the thickening of the (base) nonwoven insulation 2, if required, including the necessary transport systems. On the one hand a pick-and-place station and on the other hand the fiber blowing system.

The heating station 5 for the nonwoven insulation 2 can here comprise a radiant heating field or a hot-air oven; the heating station 5 for the wear layer a radiant heating field, depending on the material structure also a contact heating field.

It should also be noted that the temperature impact on the wear layer is limited by the fiber/yam material in particular and that underlays must not be destroyed by the applied temperature.

With nonwoven insulation 2, it must be ensured that the fiber-nonwoven structure is not destroyed by the temperature control.

On the other hand, temperatures should be present in the wear layer as well as in the nonwoven insulation 2 itself that allow stretching/stretching (without, for example, individual layers melting or tearing). In terms of time/temperature control, it must also be taken into account that the final component must meet the requirements of the automotive industry. In particular, the climate change test (shrinkage) and the wear behavior should be mentioned here.

In an embodiment, the method is further characterized in that the heating of the wear layer and the nonwoven insulation 2 is carried out independently of each other and, in particular, the wear layer can be stretched flat with the nonwoven insulation 2 in at least one direction before lamination and forming (the lamination and forming in the forming tool 7 located in the lamination press 6).

In an embodiment, the method according to the invention is further characterized by the fact that the wear layer is stretched over its surface in at least one direction, wherein the extent of the stretching being different over the course of an axis perpendicular to the stretching direction within the stretching plane (thus in particular longitudinally or transversely). Surprisingly, it has been shown that significant material savings can be realized by stretching the wear layer over its entire surface in at least one direction, and in particular by stretching to different extents over the course of an axis perpendicular to the stretching direction.

In an embodiment, the wear layer is stretched in the radiator heating field 5 or during transport to the forming press 6.

In an embodiment, the heated wear layer is stretched before molding and, in particular, stretched to varying degrees in the transverse direction over the course of its longitudinal side. Alternatively, the wear layer is stretched over the course of its transverse side to varying degrees in the longitudinal direction; in the radiant heating field 5 with specially positioned gripper systems. Generally, the stretching can take place in one or more directions.

The extent of stretching is between 5% and 20% in the longitudinal direction (through direction); and between 5% and 35% in the transverse direction.

The stretching can be carried out, for example, with the help of grippers, which are arranged along one side of the wear layer and are individually controllable. In this way, the extent of the stretching can be determined individually for each gripper, so that the side to which the grippers are attached can be stretched to a different extent in a direction perpendicular to this side.

The grippers can, for example, be part of a transport system 8 with which the wear layer is transported from the radiant heating panel 5 to the forming press 6. In particular, the wear layer can be stretched during transport by grippers on the transport system in the transverse direction in relation to the transport direction.

In an embodiment, the wear layer and the nonwoven insulation 2 are transported into the closing forming tool 7 following the contour of the tool. In particular by rotatable grippers (clamping tongs in the gripper) on the transport system 8 and by the grippers in/on the forming press 6, if applicable, guided into the closing forming tool 7. The subsequent flow of the wear layer and nonwoven insulation 2 can thus be controlled. Ibis enables the layers to be guided in correlation to the contour of the forming tool 7 (reduction of the degree of extraction, avoidance of creasing).

Furthermore, the separate heating of the wear layer and the nonwoven insulation 2 ensures that the density distribution in the nonwoven insulation 2 is not destroyed by the process control.

The forming press 6 with forming tool 7 is used for forming. In particular, the forming press 6 has a double-sided controlled stroke, a tool centering device, a tool clamping device, a tool turning device in the upper or lower table and/or a tool changing system.

The forming press 6 can be equipped with height and width adjustable grippers. In particular, the gripper system has a controlled stroke and can be adapted to different tool dimensions. A controlled opening and closing of the grippers can be possible.

In an embodiment, the grippers are rotatable and suitable to enable a controlled flow of the wear layer and nonwoven insulation 2 according to the tool contours. The grippers are particularly suitable for stretching the wear layer and, if applicable, the nonwoven insulation 2 in the through feed direction before and/or during the closing of the tool. The grippers can be controlled individually and thus enable stretching in the through feed direction to varying extents over an axis perpendicular to the through feed direction.

In an embodiment, the method according to the invention thus enables efficient process control with regard to the introduction of the process temperature into the wear layer and the nonwoven insulation 2. This ensures a component-specific laminating and forming process. In particular, the required process temperature can be introduced into the wear layer and nonwoven insulation 2 without individual layers being destroyed by burning, melting or tearing, which also enables a strong and durable lamination.

The applicant reserves the right to claim all features disclosed in the application documents as essential to embodiments of the invention, provided they are individually or in combination new compared to the conventional art. It is further pointed out that the individual figures also describe features which may be advantageous in themselves. The skilled person immediately recognizes that a certain feature described in a figure can also be advantageous without adopting further features from this figure. Furthermore, the skilled person recognizes that advantages can also result from a combination of several features shown in individual figures or in different figures.

Although the present invention has been disclosed in the form of embodiments and variations thereon, it will be understood that numerous additional modifications and variations could be made thereto without departing from the scope of the invention.

For the sake of clarity, it is to be understood that the use of “a” or “an” throughout this application does not exclude a plurality, and “comprising” does not exclude other steps or elements. The mention of a “unit” or a “module” does not preclude the use of more than one unit or module.

1. A method for producing a sound insulation, a paneling with nonwoven insulation for a vehicle, wherein the nonwoven insulation and/or the floor paneling having different acoustic and/or mechanical-physical properties over the surface and/or thickness, of the nonwoven insulation, wherein the paneling having at least one material structure wear layer, a surface/visible surface layer with sublayers located underneath and the nonwoven insulation, wherein
the nonwoven insulation is a single-layer or multilayer nonwoven which has a density distribution over its length and/or width and which oriented over its entire surface or partially towards the wear layer, wherein the tempered nonwoven being positioned in a forming tool and is preformed by closing and reopening the forming tool, thicknesses and/or contour jumps of the insulation being compensated for and by blowing in fibers and/or inserting nonwoven pads, subsequently the tempered wear layer is placed over it and the forming tool closes and opens after a defined form closing time and the formed wear layer with connected nonwoven insulation is removed and subsequently trimmed.

2. A method for producing a sound insulation, paneling with nonwoven insulation for a motor vehicle,
wherein the non-woven insulation and/or the floor paneling has different acoustic and/or mechanical-physical properties over the area and/or thickness of the non-woven insulation, wherein the paneling has at least one material structure wear layer, a surface/visible surface layer with sublayers located underneath and the non-woven insulation, wherein
the nonwoven insulation is a single-layer or multilayer nonwoven which has a density distribution over the length and/or width and has fibers oriented over the entire surface or partially towards the wear layer,
wherein the tempered nonwoven is positioned in a forming tool,
the tempered wear layer is then arranged over it, the forming tool closes and opens after a defined form closing time, the formed wear layer with bonded nonwoven insulation is removed and subsequently trimmed.

3. The method according to claim 1, wherein the pads are positioned in 2D board form or in 3D preformed form.

4. The method according to claim 1, wherein the wear layer with underlying sublayers and nonwoven insulation are heated in separate process steps, wherein the nonwoven insulation being heated in a heating station with hot air flow and/or by (short-wave) radiation and/or the wear layer being heated in a heating station with an IR radiation field or in a contact heating field.

5. The method according to claim 1, wherein the nonwoven insulation has a density distribution (weight per unit area distribution) over length and width and has fibers oriented over the entire surface or partially towards the wear layer.

6. The method according to claim 1, wherein the nonwoven insulation comprises a base nonwoven with nonwoven pads partially distributed over the surface in a predetermined manner.

7. The method according to claim 1, wherein the nonwoven insulation comprises a recycled sandwich nonwoven, having fiber scattering material with different scattering amounts over the length and width of the nonwoven in the core layer.

8. The method according to claim 1, wherein the wear layer is stretched before forming and is stretched, over the course of a longitudinal side to a varying extent in the transverse direction and/or over the course of a transverse side to a varying extent in the longitudinal direction.

9. The method according to claim 1, wherein the wear layer and the nonwoven insulation are positioned in the forming tool following the tool contour.

10. The method according to claim 1, wherein this is used for the production of further sound insulation in the interior.

11. A sound insulation, a paneling with nonwoven insulation for a vehicle, wherein the nonwoven insulation and/or the floor paneling having different acoustic and/or mechanical-physical properties over the area and/or thickness, of the nonwoven insulation, wherein the floor paneling having at least one material structure wear layer, a surface/visible surface layer with sublayers located underneath and the nonwoven insulation, wherein the nonwoven insulation is a single-layer or multilayer nonwoven which has a density distribution over length and width and which has fibers oriented over the entire surface or partially towards the wear layer, wherein thicknesses and/or contour jumps of the nonwoven insulation being compensated for by blown-in fibers and/or inserted nonwoven pads.

12. The sound insulation according to claim 11, wherein the nonwoven insulation is a multilayer nonwoven in which the compression hardness of a nonwoven layer and, of the nonwoven layer which adjoins the wear layer is lower than that of the nonwoven layer or nonwoven layers which lie towards the vehicle floor.
